(19) United States
(12) Patent Application Publication
(10) Pub. No.: US 2009/0179370 A1
(43) Pub. Date: Jul. 16, 2009

(54) WORKPIECE SHIFTING PREVENTION DEVICE

(75) Inventors: CHING-CHENG YANG, Tu-Cheng (TW); WEN-CHIH CHIU, Tu-Cheng (TW); SHOU-MING LIANG, Tu-Cheng (TW); YAW-SHEN LAI, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/101,134

(22) Filed: Apr. 10, 2008

(30) Foreign Application Priority Data
Jan. 11, 2008 (CN) 200810300075.6

(51) Int. Cl. B23Q 3/00

(52) U.S. Cl. 269/289 R

(57) ABSTRACT

A workpiece shifting prevention device includes a platform, which is configured for supporting a workpiece thereon; a sensor group mounted in the platform, which is configured for measuring pressures at different points on the platform and converting the pressures into voltage signals; an amplifier group connected to the sensor group, which is configured for amplifying the voltage signals output from the sensor group; and a single chip connected to the amplifier group, which is configured for receiving and processing the amplified voltage signals. The single chip checks if the voltage signals output from the sensor group are equal, and if not, adjusting machining parameters of an implement connected thereto.

### BACKGROUND

1. Field of the Invention

The present invention relates to shifting prevention devices, and particularly to a workpiece shifting prevention device.

2. Description of Related Art

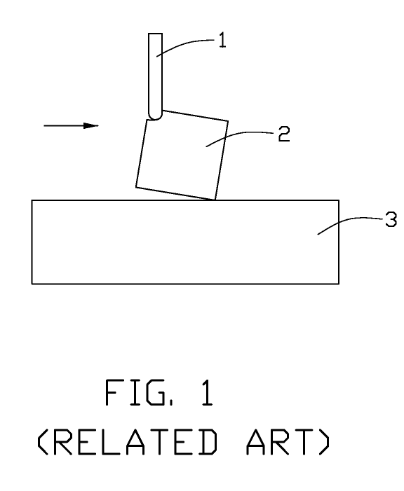

Referring to FIG. 1, in a computer numerical control (CNC) machining system a workpiece 2 is placed on a block 3. During the machining process, a reamer 1 having a cutting blade machines the workpiece 2, the arrow indicates the machining direction of the reamer. If the workpiece 2 shifts during this process due to excessive radial pressure (as shown), the resulting workpiece 2 may not be properly machined per the user's intent.

What is needed, therefore, is a workpiece shifting prevention device which can solve the problems mentioned above.

### SUMMARY

An embodiment of a workpiece shifting prevention device includes a platform, which is configured for supporting a workpiece thereon; a sensor group mounted in the platform, which is configured for measuring pressures at different points on the platform and converting the pressures into voltage signals; an amplifier group connected to the sensor group, which is configured for amplifying the voltage signals output from the sensor group; and a single chip connected to the amplifier group, which is configured for receiving and processing the amplified voltage signals. The single chip checks if the voltage signals output from the sensor group are equal, and if not, adjusting machining parameters of an implement connected thereto.

Other advantages and novel features of the present invention will become more apparent from the following detailed description of preferred embodiment when taken in conjunction with the accompanying drawing, in which:

### BRIEF DESCRIPTION OF THE DRAWINGS

The FIG. 1 is a sketch map of a workpiece machined with former technology; and

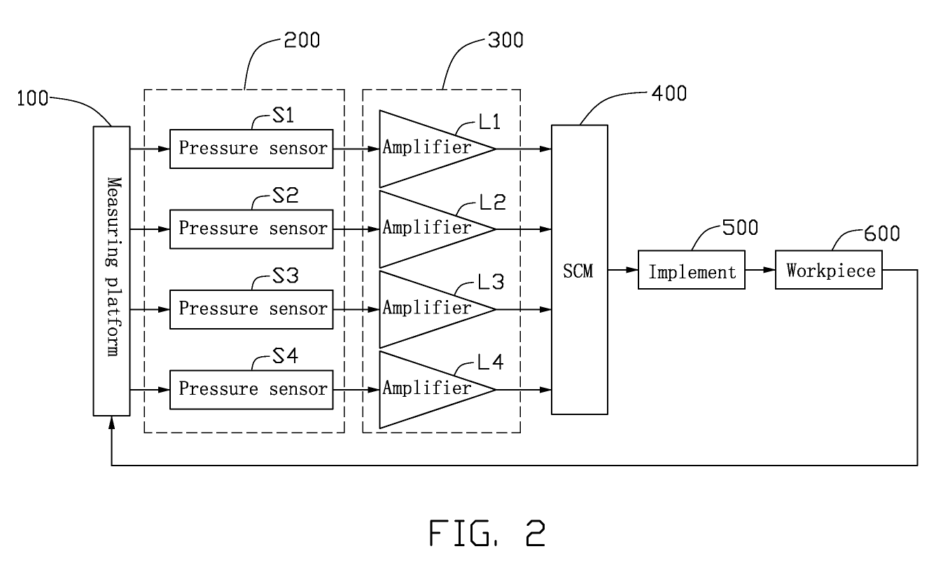

The FIG. 2 is a circuit diagram of a workpiece shifting prevention device in accordance with an embodiment of the present invention.

### DETAILED DESCRIPTION

Referring to FIG. 2, a workpiece shifting prevention device in accordance with an embodiment of the present invention includes a platform 100, a sensor group 200, an amplifier group 300, a single chip microcomputer (SCM) 400, and an implement 500 which is configured to machine a workpiece 600.

The platform 100 has a square configuration. The workpiece 600 is placed on the middle of the platform 100 to ensure that the pressure applied on four corners of the platform 100 by the workpiece 600 is symmetrical.

The sensor group 200 includes four pressure sensors S1, S2, S3, and S4, which are respectively mounted on the four corners of the platform 100 to sense pressure applied to the four corners of the platform 100 and convert the pressures into four voltage signals.

The amplifier group 300 includes four amplifiers L1, L2, L3 and L4. Inputs of the amplifiers L1, L2, L3 and L4 are respectively connected to the pressure sensors S1, S2, S3, and S4 to receive and amplify the voltage signals.

The SCM 400 is an 8051 single chip. The SCM 400 is connected to the amplifier group 300 to receive the amplified voltage signals. The SCM 400 compares the amplified voltage signals and adjusts the machining parameters of the implement 500 automatically when the amplified voltages are different from each other. In this embodiment, the implement 500 is adapted for use with a CNC lathe.

The pressure sensors S1, S2, S3, and S4 are designed to detect even the slightest discrepancy between the four pressures. The four sensors S1, S2, S3 and S4 sample the pressures at the four corners of the platform 100 continuously and convert them into voltage signals, sending the voltage signals to the SCM 400 via the amplifier group 300.

The workpiece 600 is placed on the middle of the platform 100 before it is machined, and clamped by a clamping device, such as a vice. If during the clamping procedure, shifting of the workpiece 600 occurs, the pressures at the four corners of the platform 100 will change and become different from each other, and the voltage signals output from the amplifier group 300 will change accordingly. At this point, the position of the workpiece 600 can be fine-tuned by using a hammer to reposition the workpiece 600 until the voltages are equal. The SCM 400 stores an initial machining parameter of the implement 500.

When the voltage signals received by the SCM 400 are equal, it signifies that the workpiece 600 is properly positioned, thus the implement 500 machines the workpiece 600 according to the initial machining parameters. If the machining velocity of the implement 500 is so fast that the radial pressure on the workpiece 600 is excessive, and the voltage signals output from the amplifier group 300 change from being equal, for example, the voltages output from the amplifiers L1 and L2 are unequal to the voltages output from the amplifiers L3 and L4, it signifies that shifting of the workpiece 600 may occur. So the SCM 400 adjusts the machining parameters of the implement 500 automatically, which includes reducing the machining velocity and the cutting force, thus reducing the radial pressure of the workpiece 600 until the voltages output from the amplifiers L1 and L2 are equal to the voltages output from the amplifiers L3 and L4, thereby keeping the workpiece 600 properly positioned.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A workpiece shifting prevention device comprising:
a platform configured for supporting a workpiece thereon;
a sensor group mounted in the platform, which is configured for measuring pressures at different points on the platform and converting the pressures into voltage signals;
an amplifier group connected to the sensor group, which is configured for amplifying the voltage signals output from the sensor group; and
a single chip connected to the amplifier group, which is configured for receiving and processing the amplified voltage signals, the single chip checks if the voltage signals output from the sensor group are equal, and if not, adjusting machining parameters of an implement connected thereto.

2. The workpiece shifting prevention device as claimed in claim 1, wherein the platform has a square configuration.

3. The workpiece shifting prevention device as claimed in claim 2, wherein the sensor group comprises four sensors which are mounted to four symmetrical points on the platform.

4. The workpiece shifting prevention device as claimed in claim 3, wherein the amplifier group comprises four amplifiers, and inputs of the amplifier group are connected to the sensor group.
